(19) United States
(12) Patent Application Publication
(10) Pub. No.: US 2009/0207411 A1
(43) Pub. Date: Aug. 20, 2009

(54) Aligning Multiple Image Frames in an LCoS Projector

(76) Inventor: William S. Oakley, San Jose, CA (US)

Correspondence Address: TIPS GROUP;c/o Intellevate LLC, P. O. BOX 52050, Minneapolis, MN, 55402, US

(21) Appl. No.: 12/033,003

(22) Filed: Feb. 18, 2008

(51) Int. Cl. G01B 11/00

(52) U.S. Cl. 356/400

(57) ABSTRACT

In one embodiment, a system for aligning multiple image frames in an LCoS projector is provided. The system includes a plurality of detectors aligned with a desired projection image of a projector. The plurality of detectors is coupled to the projector. Each detector of the plurality of detectors is aligned with an edge of the desired projection image. The plurality of detectors may be coupled to a screen distant from the projector, or part of a calibration unit associated more directly with the projector. The system may further include calibration logic in the projector. The calibration logic is to receive data from the plurality of detectors and to adjust an image of the projectors responsive to the data from the plurality of detectors.

### BACKGROUND

Projection of motion pictures in theatres is still primarily done based on film and projection technology little changed since the dawn of motion pictures. However, compared to film, digital media allows for much easier storage of representations of an image. In order to move beyond film-based projection, it would be useful to provide a digital projector which fits general theater requirements.

Furthermore, a Consortium of studios has set forth a standard for future digital projection systems. While this standard is by no means final, it provides a rough guide as to what a system must do—what specifications must be met. Thus, it may be useful to provide a digital projection system which meets the standards of the studio Consortium.

### BRIEF DESCRIPTION OF THE DRAWINGS

The present invention is illustrated by way of example in the accompanying drawings. The drawings should be understood as illustrative rather than limiting.

FIG. 1 illustrates an embodiment of a calibration system.

FIG. 2 illustrates an embodiment of an alignment system for a projector.

FIG. 3 illustrates an embodiment of a graph of image intensity in an alignment or calibration system.

FIG. 4 illustrates another embodiment of a calibration system as part of a projector.

FIG. 5 illustrates an embodiment of a process of aligning a projector.

FIG. 6 illustrates an embodiment of a process of projecting an image.

FIG. 7 illustrates an embodiment of a system using a computer and a projector.

FIG. 8 illustrates an embodiment of a computer which may be used with the projectors of FIG. 4, for example.

FIG. 9 illustrates yet another embodiment of a system using a computer and a projector.

FIG. 10 illustrates an embodiment of a network which may be used with various embodiments of the projectors and associated computers.

### DETAILED DESCRIPTION

A system, method and apparatus is provided for aligning multiple image frames in an LCoS projector. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

High resolution projector designs utilizing multiple LCoS imaging chips require the various LCoS images that make up the entire image to be accurately aligned to achieve an optimum or near-optimum display. This requires each of the images to be exactly the same size on the projection screen, (essentially no magnification variance), located in exactly the same position laterally and vertically, and not rotated with respect to each other (e.g. essentially no registration errors). A display is considered optimum when the projected image from each LCoS chip is aligned within one half pixel tolerance of all the images from the other LCoS chips in the projector, i.e. all images fall within half a pixel of an intended position.

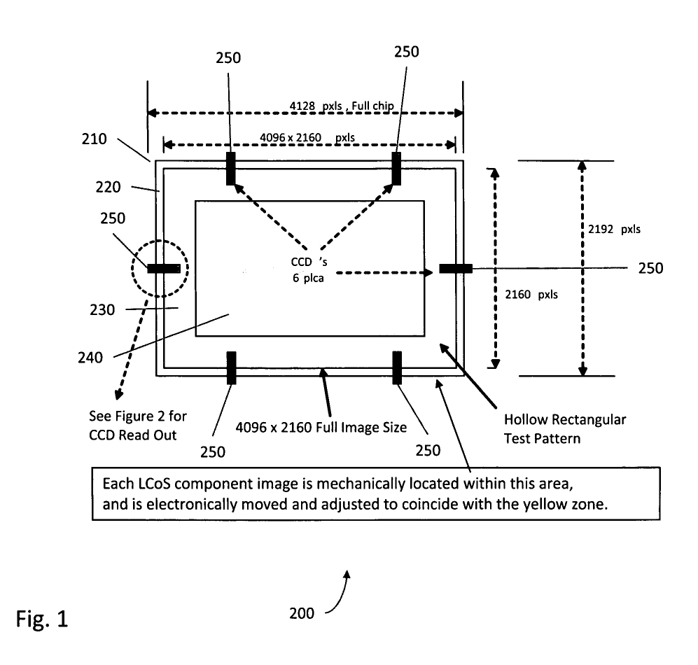

It is not economical to manufacture projectors with the close mechanical tolerances necessary for each projector to achieve and maintain the alignment of each LCoS component image to within the desired projected image tolerances. The desired alignment is achieved by mechanical alignment that overlaps the images on the screen to a given extent, and then electronically moving each image within its own chip until precise alignment with the primary image is achieved. This is accomplished by an optical alignment system and associated electronics and software program that sequentially generates the same test pattern on the screen for each LCoS component image, and which is re-imaged onto the same set of detectors in an image detection system. This system determines the precise location of the component image (frame) from the primary image, and is aligned with the primary image by digitally moving the image within the LCoS chip. During the alignment process each image (frame) location is defined by a bright, high contrast ‘hollow’ rectangular test pattern loaded into each LCoS chip so the outer edges of the projected 4096×2160 pixel image are well defined and in focus on the screen as shown in FIG. 1. The figure shows the use of CCD detectors but other detectors are also usable, e.g. diagonally split silicon detectors.

Turning specifically to FIG. 1, System 200 provides a system for aligning images in an LCoS projector, and includes a screen 210, an outer band 220, an outer image band 230, and an inner image area 240, and detectors 250. In one embodiment detectors 250 are CCD detectors as described further below. The objective of use of system 200 is to align the image on screen 210 so that the image occupies outer image band 230, without spilling over to outer band 220. Detectors 250 allow a determination as to whether an image projected on screen 210 is achieving this objective. In one embodiment, the detectors 250 are each 6 pixels wide. Furthermore, in one embodiment, the outside dimensions of outer image band 230 are 4096×2160 pixels, as specified by the studio consortium for digital projection. Moreover, in such an embodiment, the overall dimensions of screen 210 (and potentially the outer dimensions of outer band 220) are approximately 4128×2192 pixels. This allows for some space around the edges of the screen.

Placement of the detectors 250 at predetermined locations along the interface between outer band 220 and outer image band 230 allows for determination of whether an image is within outer image band 230 or not. Note that in some embodiments, a screen is not used—rather, detection occurs in a sensor integrated with the projector. In such an instance, screen 210, outer band 220, outer image band 230 and inner image area 240 are portions of a sensor array. In particular, such portions of the system may be defined in relation to positioning of a set of detectors 250 within such a system, and the detectors 250 may be the only detection components present. Moreover, in such a system, detectors 250 need not have the same pixel size in absolute dimensions that one would have on a projector screen—a closer detector with smaller pixels would provide appropriate functionality.

Referring to digital LCoS projectors generally, the primary image in a projector is electronically centered in its LCoS chip. To effectively move the image of each other LCoS chip, the chip has to be larger than the 4096×2160 primary image in an amount determined by the mechanical mounting accuracy of each LCoS chip. For example, if each LCoS chip in the projector is mechanically aligned to within ±0.0047 inches of a correct location relative to the primary, and the chip is 1.200 inches wide, the alignment range is (±0.0047/1.200)×4096 or ±16 pixels. The LCoS chip must then be 4096±16 pixels wide, and 2160±16 pixels high. Thus, one may use an LCoS chip that is 4128 pixels wide by 2192 pixels wide to achieve the desired tolerances. Other tolerances may be achievable, depending on available manufacturing capabilities and LCoS components in various embodiments.

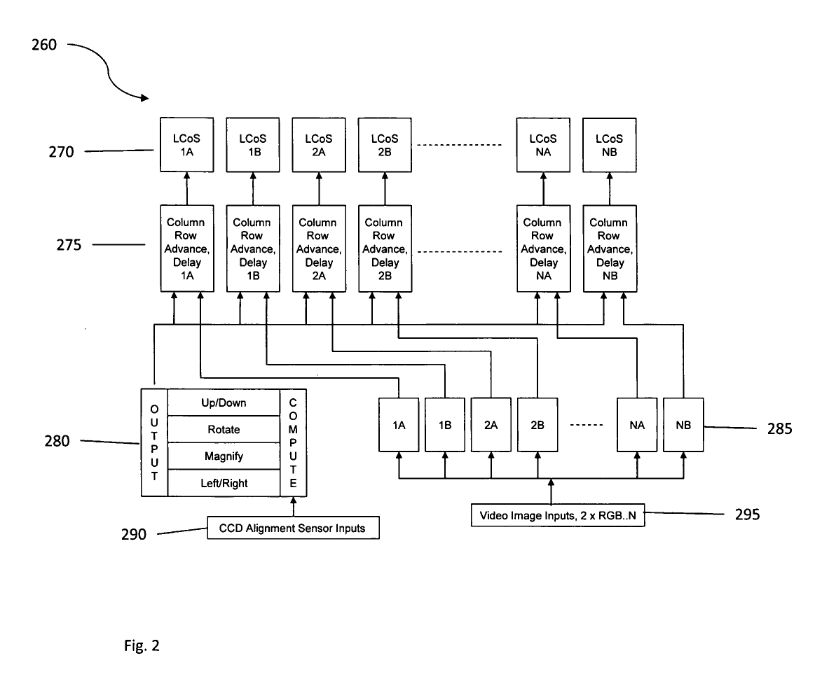

The full image is composed of separate RGB and polarization images, a 3D RGB image includes six separate component images, with each type of image potentially assigned to a specific chip. Each frame can be individually moved within the chip by adjusting the clock counts for the rows and/or columns of each frame. The six frames are optically combined to form a single image by aligning each frame within the 4128×2192 pixel chip. E.g. the first pixel of the primary image is located at chip column location +16 and row location +16. The first pixel of the second chip can be adjusted by ±16 pixels in both columns and rows to exactly overlay the first pixel of the first chip, etc. As a result, the top left corner of each frame can be placed exactly in the same position on the screen (or very nearly so). Rotation and magnification adjustments can be achieved by adjusting clock counts within the image rows or columns. A suggested system for doing this is shown in FIG. 2.

Turning more specifically to FIG. 2, system 260 provides a system for adjusting image position in LCoS chips on an individual basis. System 260 includes video image inputs 295, image buffers 285, sensor inputs 290, calibration logic 280, image adjustment logic 275 and LCoS chips 270. System 260 operates with data flowing in through video image inputs 295—such as from an associated computer or from a video sensor, for example. Image buffers 285 receive the video data and provide the data to LCoS chips. Logic controlling a bus between inputs 295 and buffers 285 may steer data to correct buffers—such as in a graphics processor, for example.

Separately, sensor inputs 290 collect information about the projected image, and provide that information to calibration logic 280. This may occur on a continuous basis, on an incidental basis as requested by a system or a user, or it may occur based on affirmative steps for calibration (such as deploying and connecting calibration sensors, for example). Calibration logic 280 interprets data from sensors 290 to determine registration/alignment errors in the projected image, and determines appropriate adjustments to image data for each LCoS chip. Image adjustment logic 275 then uses data from calibration logic 280 to adjust the flow of data from image buffers 285 to LCoS chips 270. Each LCoS chip 270 may have associated adjustment parameters implemented by an associated image adjustment logic module 275. This may, in turn, result in corresponding pixel data going into different pixels depending on which LCoS chip 270 is being provided data to account for registration and alignment errors.

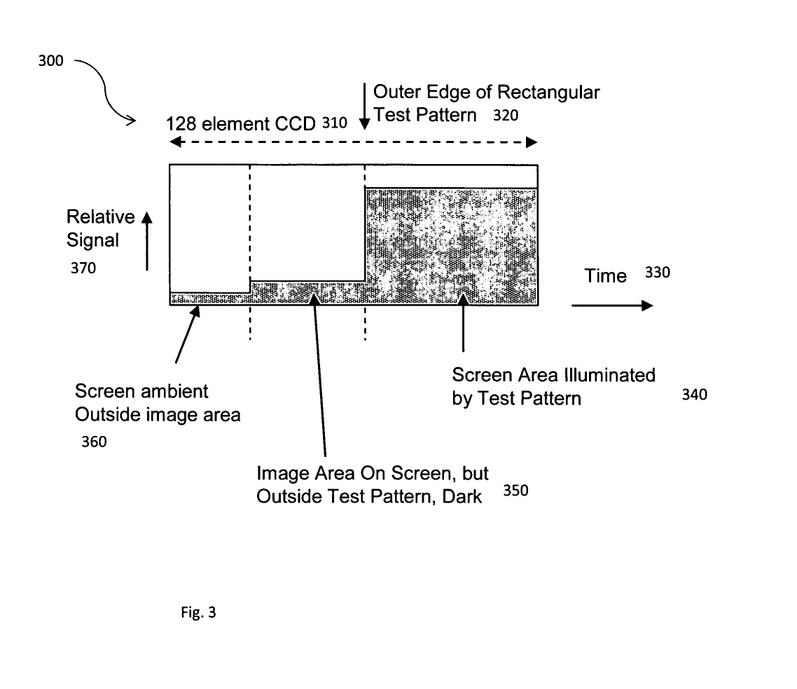

The alignment system may be co-located or integrated with the projector and may contain a number of linear CCD detector arrays positioned as shown in FIG. 1 in some embodiments. Image focus is determined by the steepness of the edge read out by the CCD sensor array, such as that shown in FIG. 3. This allows image focusing on the screen to be performed electronically if required. Focusing the initial image (frame) on the screen is achieved by activating the primary LCoS chip and maximizing the difference in signals between the test pattern image outer edge (e.g. outer image band 230) and adjacent background (outer band 220) outside the test pattern. All LCoS chips may be positioned within the optical system so that each individual frame image is in focus at the output image plane of the final projection lens. For the primary image the steep step response can be located anywhere on the CCD detector, but subsequent LCoS images must be aligned to the same detector element in all detectors. That is, the primary image may have a relatively arbitrary location, but the remaining images then need to be aligned to the primary image.

Turning more specifically to the readout of FIG. 3, a readout of a detector such as a CCD over time (reading out detector positions serially over time) is provided. A relative signal value 370 is plotted over time 330. For a 128 element CCD sensor 310, a readout over time provides a readout along a series of positions. Thus, a portion of the readout corresponds to area 360—the area outside the image, and an expected value here is roughly the ambient light value. Additionally, an image area 350 corresponds to a portion of the screen which is dark—no image data is expected. Light leakage or dark currents may result in a value somewhat greater than ambient for this area. Screen area 340 is the portion of the image that is to be illuminated, and has a correspondingly higher signal 370. The breakpoint between dark image area 350 and screen area 340 thus represents outer edge 320. The location of outer edge 320, as adjusted by any calibration, can allow for proper registration of separate images. That is, causing the outer edges 320 of different images to line up should lead to desired alignment.

If diagonally split silicon detectors are employed the image positioning system (IPS) must first be precisely aligned with the primary image so the signals from each half of the detector are equal. The diagonal detectors do not provide a signal for image focusing and require the primary image of the rectangular test pattern be of a specific size on the detectors. This is best achieved by electronically adjusting the primary image test pattern size, orientation, and location to the detector pattern, rather than permitting a relatively arbitrary image position for the primary image.

After focusing the initial image (frame) on the screen, alignment is achieved by activating primary LCoS chip with the hollow rectangular test pattern and adjusting the image position within an electronic memory to center the image of the projected display in the focal plane of a pre-aligned image sensor. For an image of say 4096 pixels horizontally, the image memory should be about ±16 pixels (pxls) larger, i.e. 4,128 pixels wide, corresponding to ± 1/258 of the image width in some embodiments. For an image chip of 1.2 inches width this corresponds to a mechanical positional tolerance range of ±0.0047 inches.

Image Alignment Functions

Top edge alignment and image rotation: In an embodiment, two CCD sensor arrays are located each nominally ⅛ of the distance in from the image sides so as to cross symmetrically the top edge of the projected image with each sensor array having 128 sensor elements arranged vertically. The sensor optical system magnification is designed so one sensor element corresponds to ¼ pixel. The remaining chips each illuminate the screen in sequence and their images are adjusted vertically and rotated within the electronic memories to match the CCD detector patterns for each chip. That is, images for succeeding LCoS chips are adjusted to match a primary image profile on the detectors in question. This aligns the top edges of each chip image and eliminates rotation between the images, both to within less than one pixel.

Magnification: In one embodiment, a single CCD array is positioned at nominally the midpoint of the image bottom edge so the edge of the projected image crosses about midpoint on the vertically aligned sensor. The magnification of each individual image of each LCoS chip is adjusted within the electronic memory so that each image is of the same magnification to within one pixel of the primary image.

Side edge alignment: In one embodiment, two CCD array sensors are positioned within the alignment system so as to cross the two edges of the projected image horizontally, at about the mid point of the image vertical sides. The images are electronically moved sideways within the memory to align the edges of all images with each other—each image from the various LCoS chips is adjusted to match the primary image.

As all LCoS chips are fabricated from the same mask set the image aspect ratio is expected to be the same for all images and the image magnification need only be adjusted in one axis. However, adjustment along a side can be used to adjust magnification issues if such adjustment is deemed necessary.

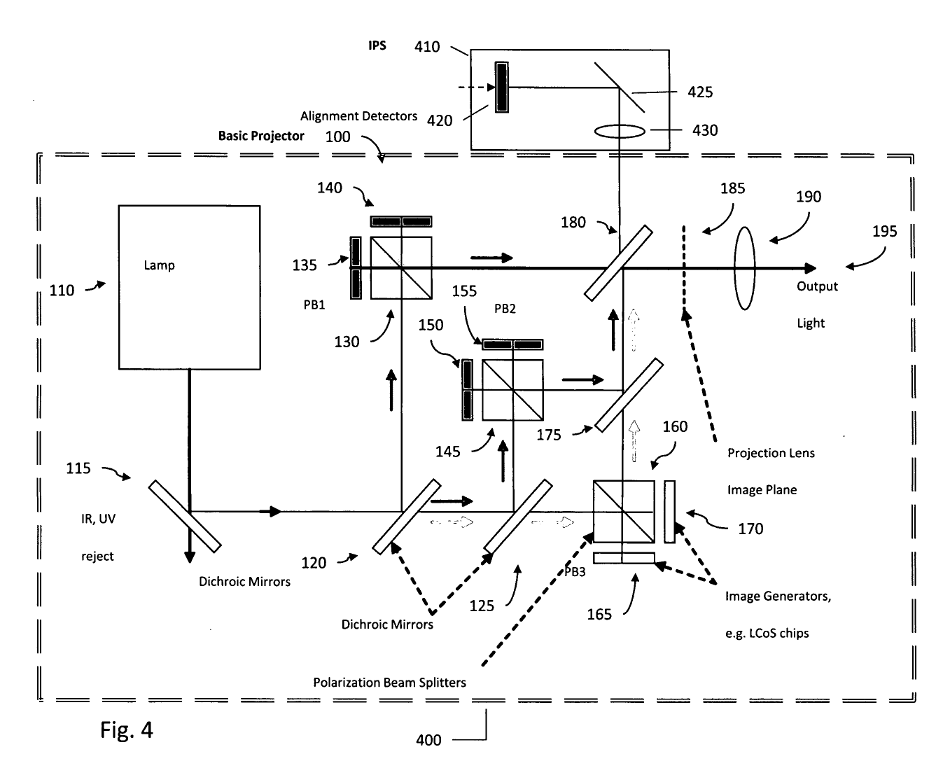

The Image Positioning System (IPS) includes a lens and a set of detectors as shown in FIG. 1 located in an image plane of all the image generators and may either be integrated with or separate from the projector. If separate from the projector the IPS obtains power from the projector and returns signals to the projector, and is operated by mechanically aligning the system so the primary image is located with respect to the image detectors as shown in FIG. 1. The IPS is focused on the projected image on the screen and must be manually aligned to the image. One factor in an IPS that is separate from the projector is that changing projection lenses changes the image size at the screen and therefore the image size at the IPS. In some embodiments, the IPS is integrated with the basic projector and a portion of the beam with all the images is passed from the projector to the IPS as shown in FIG. 4. The dichroic mirror that combines the blue and red/green images is not perfect and a small amount of the blue light reflects from it into the IPS. Similarly a small portion of the red/green light is transmitted through the dichroic mirror to the IPS. Hence all colors and polarizations are passed to the IPS and may be sequentially aligned with the chosen primary image. With an integrated IPS using CCD sensors it is only necessary that each image generate a similar CCD output signal in the same location on each sensor, the reference being the primary image.

The integrated IPS does not view the image on the projection screen and is not useful for automatically focusing the image on the screen. Automatic focusing could be obtained by sampling the light output from the projection lens, but then changing lenses to rescale the projected image would complicate the alignment system as both the image size and focus in the IPS would vary with the lens used. Rather, a separate focusing system (potentially a manual focusing system) may be used instead of a focus system integrated with the alignment (IPS) system.

Turning now to FIG. 4, a basic projector 100 is shown as part of system 400 along with an associated IPS 410. A high efficiency optical design for three color RGB (red, green, blue) image projectors is shown in projector 100 that uses six LCoS image planes to obtain both optical polarizations in all colors and is suitable for slide or dynamic video presentations to large screens. A randomly polarized white light source (110) is stripped of IR and UV components by an IR/UV rejection filter (115) input to a first dichroic mirror (120) which reflects the blue portion of the spectrum to a polarizing beam splitter (PB1—130). The remainder of the spectrum passes through the dichroic mirror (120) to a second dichroic mirror (125), which reflects the red portion of the spectrum to a second polarizing beam splitter (PB2—145). The remaining spectrum passes to a third polarizing beam splitter (PB3—160).

Each of the three beam splitters separates its portion of the spectrum into two orthogonal polarization components, each of which is directed to an active LCoS (Liquid Crystal on Silicon) image generation plane (chips 135, 140, 150, 155, 165 and 170). Both polarization components are selectively polarization rotated on a pixel by pixel basis by an electrical signal applied to the LCoS display chips, so as to modulate the input light and impart an image onto the throughput light. Polarization modulated light is reflected from each LCoS chip back through the polarizing beam splitters (130, 145 and 160), so that both polarizations exit from the polarizing beam splitter and are re-combined with similarly processed light of the other spectral portions via dichroic mirrors (175 and 180) to form a white image (at projection lens image plane 185) which is focused on a remote screen using a projection lens (190) to provide output light 195.

Application of a voltage to an LCoS chip pixel that is insufficient for 90 degree rotation of the optical polarization results in a smaller rotation of the plane of polarization for a beam reflected from an LCoS chip. On passing back (of the beam) through the polarizing beam splitter the rotated beam is split into two orthogonal polarized components of different intensities that exit the beam splitter in different directions. Thus the intensity of the output beam is reduced in proportion to the degree of polarization rotation (i.e. voltage on the pixel), and the unrotated portion is returned along its entrance path back toward the source.

Although many optical projection systems have been designed, multicolor displays using reflective LCoS image generation chips, one design the inventor is aware of is not well suited to large high brightness displays. The LCoS image generation devices employ a liquid crystal layer sandwiched between a transparent optical surface and a silicon electronic chip which applies a voltage to the liquid crystal layer on a pixel by pixel basis, causing spatially localized polarization rotation of light and thereby enabling an image to be imparted to light input through the transparent surface and reflecting back from the chip surface. The LCoS devices are universally employed in a reflective mode where the reflected light contains the image information.

The above referenced design uses four beam splitting cubes and several color absorption filters. It suffers from a low light efficiency as the input light is first split into two polarizations, each of which is then passed through color filters. This implementation causes half of the polarized light to be absorbed in the color filters. The absorbed light significantly heats the filters, trapping the heat between the polarizing cubes. Consequently this design, although compact, is only compatible with low intensity light, perhaps small fractions of a watt. A large screen multi-media display must be capable of transmitting several hundred watts of light, with potentially tens of watts absorbed in the image generating chips.

In contrast the proposed optical design implementation first separates the input light on a spectral basis, blue, red, then green light, using color separating dichroic mirrors, and each color is then input to its own polarizing beam splitter which directs polarized light to two LCoS image planes, one for each light polarization state. The light is thus spread over six separate LCoS chips. The reflected output images from the three beam splitters each contain both optical polarizations for their respective color, and the colored images are then re-combined using dichroic mirrors. By this means no light is absorbed in color filters and the system is capable of much higher optical power throughput as the dichroic mirrors absorb comparatively little light, and each color path is very efficient with minimal light loss at the LCoS planes. The LCoS image chips are accessible from the rear (the non-image side) and active chip cooling may therefore be employed to maintain each chip within a preferable operating temperature range.

In one embodiment, the blue light is first separated using a blue reflecting, red and green transmitting dichroic mirror. Blue light is separated first as, for a maximum brightness display, it can least tolerate optical power losses, and some red and green light is lost at the blue reflecting dichroic mirror. Next the red light is separated as this is less tolerant to loss than the green portion of the spectrum. Reflection spectra of typical dichroic mirrors are shown in FIG. 2, with FIG. 2A showing a blue reflecting dichroic mirror and FIG. 2B showing a red reflecting dichroic mirror.

After passing through their respective LCoS image planes each color is recombined using dichroic mirrors similar to those used in the initial color separation process. It is noted the two re-combining dichroic mirrors are very angle sensitive as rotations will move the image planes out of registration. In an embodiment, the optical path lengths from the optical source to each LCoS image plane is essentially the same to enable essentially the same illumination fill factor and pattern to be obtained for each image plane. Similarly the three output colored images from the LCoS are all essentially equidistant from the projection lens, thereby enabling all images to be projected in focus.

The three images are typically combined in the image plane of the projection lens enabling existing projection lenses to be used. The images from the LCoS image generation chips are relayed to the projection lens image plane using standard relay lens techniques to maximize light throughput. The optical paths are arranged so that a single set of relay optics relays the image from each LCoS chip to the projector lens image plane. The relay optics is configured so the magnification from the LCoS image chips to the output image plane matches the output image plane format.

The basic optical system of projector 100 lies in a plane in some embodiments, which minimizes the number of optical elements, thereby minimizing scattered light and maintaining maximum image contrast. Each beam splitting cube is mounted on the same surface and all optical paths are co-planer. This facilitates fabrication and optical alignment. The co-planar layout also facilitates thermal control of the LCoS image generators as ‘through the support-plate’ airflow in a direction perpendicular to the plane of the optical system is easily configured and keeps the cooling air away from the optical path, reducing the possibility of optical artifacts created by air turbulence.

The LCoS image projector may use existing projection display components such as lamp houses and associated power supplies, and available projection lenses. Both lamp houses and projection lenses are typically close to the image plane in film projectors. The light output from the lamp house is therefore relayed to the LCoS image chips by illumination relay optics with a magnification that matches the lamp output area to the image chip area.

IPS 410 receives what would otherwise be wasted light—light from dichroic mirror 180 which would not go to projection lens 185. The received light is focused by lens 430 and reflects off of mirror 425 to alignment detectors 420. Alignment detectors 420 may then be used to adjust image input data for each of LCoS chips 135, 140, 150, 155, 165 and 170.

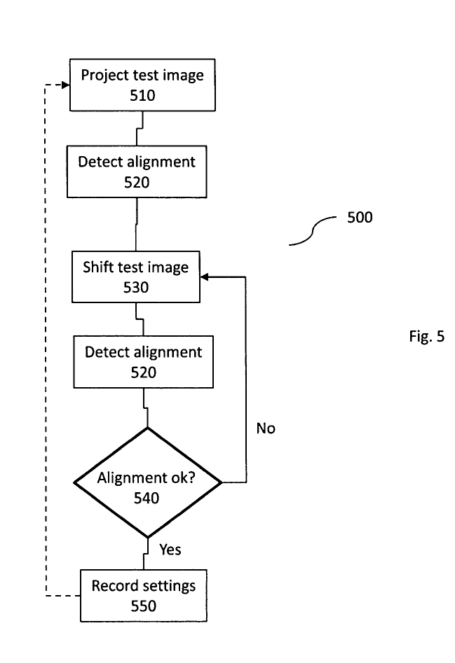

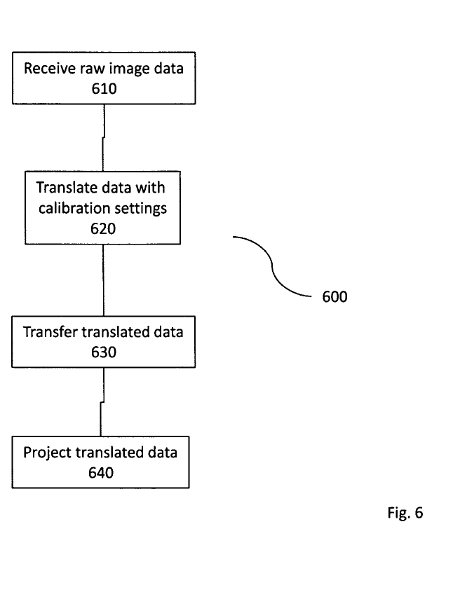

The systems described herein may be expected to implement various processes. Examples of an alignment process and a projection process are provided in FIGS. 5 and 6. Additionally, the processes of FIGS. 5 and 6 may be implemented in a simultaneous manner, to adjust alignment/registration in a dynamic manner.

FIG. 5 illustrates a process of aligning images from a projector. Process 500 includes projecting a test image, detecting alignment, shifting the test image if necessary, further detecting alignment, determining if alignment is acceptable, and recording settings for the image. Process 500 and other processes of this document are implemented as a set of modules, which may be process modules or operations, software modules with associated functions or effects, hardware modules designed to fulfill the process operations, or some combination of the various types of modules, for example. The modules of process 500 and other processes described herein may be rearranged, such as in a parallel or serial fashion, and may be reordered, combined, or subdivided in various embodiments.

Process 500 begins in an embodiment with projection of a test image at module 510. Alternatively, any image expected to provide illumination in parts of the image where calibration is tested may be projected. At module 520, alignment of the image with the desired projection of the image is detected. This may refer to alignment with a reference image, or to alignment with a predetermined standard, for example.

If necessary, at module 530, a shift is made in the test image, based on an indication that the image is out of alignment. Depending on the type of alignment tested in a given process, this may involve “raising” or “lowering” the image (shifting vertically), translating the image to one or another side (shifting horizontally) or rotating the image. Following the shift to the test image, alignment is detected again at module 520. At module 540, a determination is made as to whether the alignment status is now acceptable. If not, the process returns to module 530. If so, the process moves to module 550.

Process 500 may be repeated for each of a set of LCoS chips in some embodiments. Additionally, in some embodiments, process 500 may be repeated for each of a set of different types of alignment, such as rotation, linear translation (horizontal and/or vertical) and magnification. Thus, the alignment process may include a number of different instances of process 500, some of which may be executed in parallel in some embodiments.

In contrast, FIG. 6 provides an illustration of an embodiment of a process of projecting an aligned image. Process 600 includes receiving raw image data, translating the data with calibration settings, transferring translated data to LCoS projection chips, and projecting the translated data. Process 600 begins with receipt of raw image data at module 610. At module 620, the raw image data is translated to new coordinates based on calibration (alignment) data. At module 630, the translated data is provided to a projection mechanism (such as an LCoS chip) and at module 640, the translated data is projected.

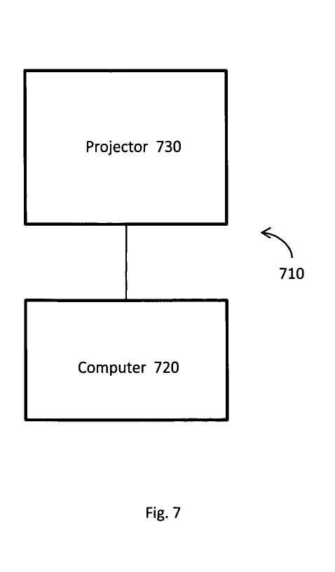

FIG. 7 illustrates an embodiment of a system using a computer and a projector. System 710 includes a conventional computer 720 coupled to a digital projector 730. Thus, computer 720 can control projector 730, providing essentially instantaneous image data from memory in computer 720 to projector 730. Moreover, computer 720 can implement calibration and image translation functions internally, based on feedback from an associated IPS of projector 730. Projector 730 can use the provided image data to determine which pixels of included LCoS display chips are used to project an image. Additionally, computer 720 may monitor conditions of projector 730, and may initiate active control to shut down an overheating component or to initiate startup commands for projector 730.

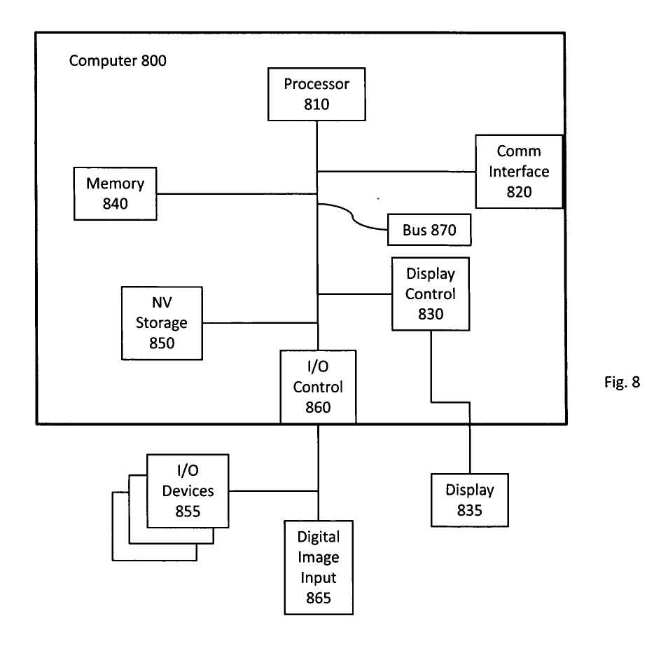

FIG. 8 illustrates an embodiment of a computer which may be used with the projectors of FIG. 4, for example. The following description of FIG. 8 is intended to provide an overview of computer hardware and other operating components suitable for performing the methods of the invention described above and hereafter, but is not intended to limit the applicable environments. Similarly, the computer hardware and other operating components may be suitable as part of the apparatuses and systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 8 shows one example of a conventional computer system that can be used as a client computer system or a server computer system or as a web server system. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems. In the case of a closed network, a hardwired physical network may be preferred for added security.

The computer system 800 includes a processor 810, which can be a conventional microprocessor such as microprocessors available from Intel or Motorola. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). Display controller 830 can, in some embodiments, also control a projector such as those illustrated in FIGS. 1 and 5, for example. The input/output devices 855 can include a keyboard, disk drives, printers, a scanner, and other input and output devices, including a mouse or other pointing device. The input/output devices may also include a projector such as those in FIGS. 1 and 5, which may be addressed as an output device, rather than as a display. The display controller 830 and the I/O controller 860 can be implemented with conventional well known technology. A digital image input device 865 can be a digital camera which is coupled to an i/o controller 860 in order to allow images from the digital camera to be input into the computer system 800. Digital image data may be provided from other sources, such as portable media (e.g. FLASH drives or DVD media).

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

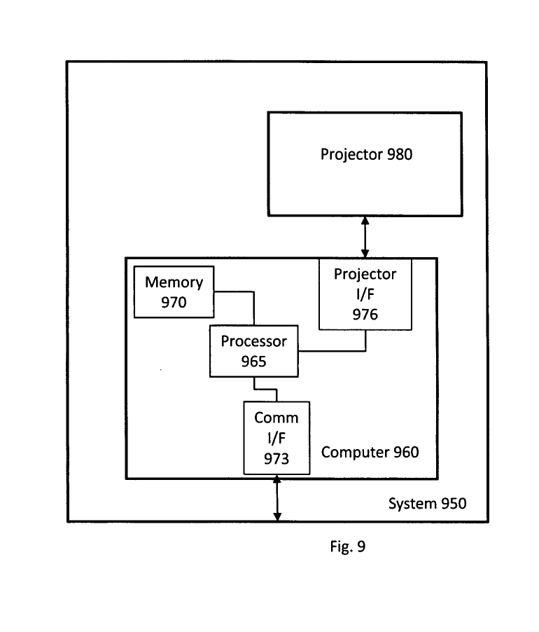

FIG. 9 illustrates another embodiment of a system using a computer and projector. System 950 includes computer subsystem 960 and optical subsystem 980 as an integrated system. Computer 960 is essentially a conventional computer with a processor 965, memory 970, an external communications interface 973 and a projector communications interface 976.

The external communications interface 973 may use a proprietary (a standard developed for such a device but not publicized by its developer), or a publicly available communications standard, and may be used to receive both digital image data and commands from a user. The projector communications interface 976 provides for communication with projector subsystem 980, allowing for control of LCoS chips (not shown) included in projector subsystem 980, for example. Thus, projector communications interface 976 may be implemented with cables coupled to LCoS chips, or with other communications technology (e.g. wires or traces on a printed circuit board) coupled to included LCoS chips. Other components of computer subsystem 960, such as dedicated user input and output modules, may be included, depending on the needs for functionality of a conventional computer system in system 950. Moreover, computer 960 can implement calibration and image translation functions internally, based on feedback from an associated IPS of projector 980. System 950 may be used as an integrated, standalone system—thus allowing for the possibility that each theater may use its own projector with a built-in control system, for example.

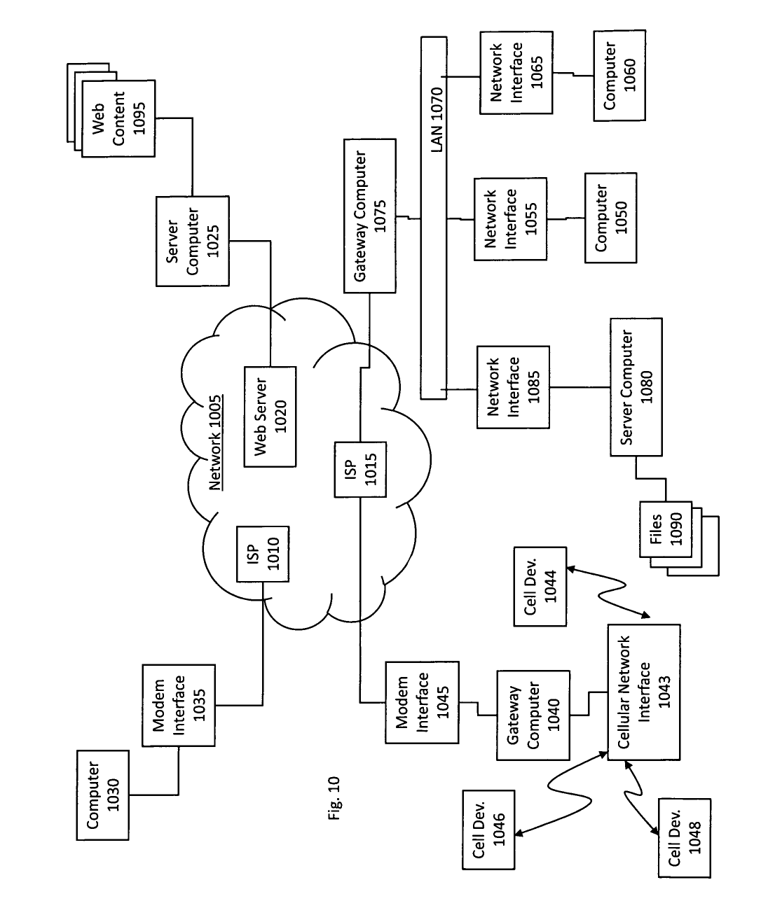

It may be useful to provide network services for a projection system. FIG. 10 shows an embodiment of several computer systems that are coupled together through a network 1005, such as the internet The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 1005 is typically provided by internet service providers (ISP), such as the ISPs 1010 and 1015. Users on client systems, such as client computer systems 1030, 1040, 1050, and 1060 obtain access to the internet through the internet service providers, such as ISPs 1010 and 1015. Access to the internet allows users of the client computer systems to exchange information, receive and send e-mails, and view documents, such as documents which have been prepared in the HTML format. These documents are often provided by web servers, such as web server 1020 which is considered to be “on” the internet. Often these web servers are provided by the ISPs, such as ISP 1010, although a computer system can be set up and connected to the internet without that system also being an ISP.

The web server 1020 is typically at least one computer system which operates as a server computer system and is configured to operate with the protocols of the world wide web and is coupled to the internet. Optionally, the web server 1020 can be part of an ISP which provides access to the internet for client systems. The web server 1020 is shown coupled to the server computer system 1025 which itself is coupled to web content 1095, which can be considered a form of a media database. While two computer systems 1020 and 1025 are shown in FIG. 10, the web server system 1020 and the server computer system 1025 can be one computer system having different software components providing the web server functionality and the server functionality provided by the server computer system 1025 which will be described further below.

Client computer systems 1030, 1040, 1050, and 1060 can each, with the appropriate web browsing software, view HTML pages provided by the web server 1020. The ISP 1010 provides internet connectivity to the client computer system 1030 through the modem interface 1035 which can be considered part of the client computer system 1030. The client computer system can be a personal computer system, a network computer, a web tv system, or other such computer system.

Similarly, the ISP 1015 provides internet connectivity for client systems 1040, 1050, and 1060, although as shown in FIG. 10, the connections are not the same for these three computer systems. Client computer system 1040 is coupled through a modem interface 1045 while client computer systems 1050 and 1060 are part of a LAN. While FIG. 10 shows the interfaces 1035 and 1045 as generically as a “modem,” each of these interfaces can be an analog modem, isdn modem, cable modem, satellite transmission interface (e.g. “direct PC”), or other interfaces for coupling a computer system to other computer systems.

Client computer systems 1050 and 1060 are coupled to a LAN 1070 through network interfaces 1055 and 1065, which can be ethernet network or other network interfaces. The LAN 1070 is also coupled to a gateway computer system 1075 which can provide firewall and other internet related services for the local area network. This gateway computer system 1075 is coupled to the ISP 1015 to provide internet connectivity to the client computer systems 1050 and 1060. The gateway computer system 1075 can be a conventional server computer system. Also, the web server system 1020 can be a conventional server computer system.

Alternatively, a server computer system 1080 can be directly coupled to the LAN 1070 through a network interface 1085 to provide files 1090 and other services to the clients 1050, 1060, without the need to connect to the internet through the gateway system 1075.

Ultimately, various embodiments can be implemented. In one embodiment, a system for aligning multiple image frames in an LCoS projector is provided. The system includes a plurality of detectors aligned with a desired projection image of a projector. The plurality of detectors is coupled to the projector. Each detector of the plurality of detectors is aligned with an edge of the desired projection image. The plurality of detectors may be coupled to a screen distant from the projector, or part of a calibration unit associated more directly with the projector. The system may further include calibration logic in the projector. The calibration logic is to receive data from the plurality of detectors and to adjust an image of the projectors responsive to the data from the plurality of detectors.

In some embodiments, an optical component is positioned at an outlet of the projector to receive calibration light from the projector. The calibration light correspond to light provided as an output beam by the projector. The calibration light is separate from the output beam. The optical component is further positioned to provide the calibration light to the plurality of detectors. In some such embodiments, the optical component includes a lens coupled to a mirror.

In some embodiments, the detectors of the plurality of detectors are CCD row elements. Moreover, in some embodiments, the CCD row elements each include 128 CCD sensors. In other embodiments, the detectors of the plurality of detectors are each split silicon light detectors. In some embodiments, the calibration logic is in the projector, and includes a set of delay logic modules coupled to image modulation components of the projector. Moreover, the calibration logic may further include control logic to receive data from the plurality of detectors and to control the delay logic modules responsive to the data from the plurality of detectors.

In another embodiment, a system is provided. The system includes a housing and first, second and third LCoS assemblies coupled to the housing. The system may further include a first beam splitter and a second beam splitter both coupled to the housing. The first beam splitter is arranged to split incoming light between the first LCoS assembly and the second beam splitter. The second beam splitter is arranged to split incoming light between the second LCoS assembly and the third LCoS assembly. The system also includes a first beam recombiner and a second beam recombiner both coupled to the housing. The first beam recombiner is arranged to receive light from the first LCoS assembly and the second LCoS assembly. The second beam recombiner is arranged to receive light from the first beam recombiner and from the third LCoS assembly.

The system further includes a first light source to provide incoming light to the first beam splitter. The system also includes an output optics element coupled to the housing and arranged to receive light from the second beam recombiner and to focus an output light source. Note that the first and second beam recombiners may be dichroic mirrors in some embodiments. The system further includes a plurality of detectors aligned with a desired projection image of a projector. The plurality of detectors is coupled to the projector. Each detector of the plurality of detectors is aligned with an edge of the desired projection image. The system also includes calibration logic. The calibration logic includes a set of delay logic modules coupled to the first, second and third LCoS assemblies. The calibration logic also includes control logic to receive data from the plurality of detectors and to control the delay logic modules responsive to the data from the plurality of detectors.

In some embodiments, the detectors are positioned on a screen. The screen is positioned at a distance from the output optics element to receive an image from the output optics element for viewing by a group of people. In other embodiments, the detectors are coupled to the housing physically in a calibration subsystem proximate to the housing and apart from a screen distant from the housing for receiving images from the housing. Moreover, in some embodiments, the system also includes an optical component positioned at an outlet of the housing to receive calibration light from the second beam recombiner. The calibration light corresponds to light provided by the output optics. The optical component is further positioned to provide the calibration light to the plurality of detectors. In some embodiments, the optical component includes a lens coupled to a mirror. Furthermore, in some embodiments, the detectors of the plurality of detectors are CCD row elements. In other embodiments, the detectors of the plurality of detectors are each split silicon light detectors.

In yet another embodiment, a method is provided. The method includes detecting alignment of a first image. The method also includes providing data indicating alignment of the first image. The method further includes adjusting the first image responsive to the data. The method may further include detecting alignment of a second image. The method may also include providing data indicating alignment of the first image with the second image. The method may further include adjusting the second image responsive to the data. Moreover, detecting alignment may include detecting registration errors, magnification and rotation in some embodiments.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. An apparatus, comprising:
A plurality of detectors aligned with a desired projection image of a projector, the plurality of detectors coupled to the projector, each detector of the plurality of detectors aligned with an edge of the desired projection image.

2. The apparatus of claim 1, wherein:
The detectors are positioned on a screen, the screen positioned at a distance from the projector to receive an image from the projector for viewing by a group of people.

3. The apparatus of claim 1, wherein:
The detectors are coupled to the projector physically in a calibration subsystem proximate to the projector and apart from a screen distant from the projector for receiving images from the projector.

4. The apparatus of claim 1, further comprising:
An optical component positioned at an outlet of the projector to receive calibration light from the projector, the calibration light corresponding to light provided as an output beam by the projector, the calibration light separate from the output beam, the optical component further positioned to provide the calibration light to the plurality of detectors.

5. The apparatus of claim 4, wherein
The optical component includes a lens coupled to a mirror.

6. The apparatus of claim 1, further comprising:
Calibration logic in the projector, the calibration logic to receive data from the plurality of detectors and to adjust an image of the projectors responsive to the data from the plurality of detectors.

7. The apparatus of claim 1, wherein:
The detectors of the plurality of detectors are CCD row elements.

8. The apparatus of claim 7, wherein:
The CCD row elements each include 128 CCD sensors.

9. The apparatus of claim 1, wherein:
The detectors of the plurality of detectors are each split silicon light detectors.

10. The apparatus of claim 1, further comprising:
Calibration logic in the projector, the calibration logic including a set of delay logic modules coupled to image modulation components of the projector, the calibration logic further including control logic to receive data from the plurality of detectors and to control the delay logic modules responsive to the data from the plurality of detectors.

11. A system comprising:
A housing;
A first LCoS assembly coupled to the housing;
A second LCoS assembly coupled to the housing;
A third LCoS assembly coupled to the housing;
A first beam splitter and a second beam splitter both coupled to the housing, the first beam splitter arranged to split incoming light between the first LCoS assembly and the second beam splitter, the second beam splitter arranged to split incoming light between the second LCoS assembly and the third LCoS assembly;
A first beam recombiner and a second beam recombiner both coupled to the housing, the first beam recombiner arranged to receive light from the first LCoS assembly and the second LCoS assembly, the second beam recombiner arranged to receive light from the first beam recombiner and from the third LCoS assembly;
A first light source to provide incoming light to the first beam splitter;
An output optics element coupled to the housing and arranged to receive light from the second beam recombiner and to focus an output light source;
A plurality of detectors aligned with a desired projection image of a projector, the plurality of detectors coupled to the projector, each detector of the plurality of detectors aligned with an edge of the desired projection image; And
Calibration logic, the calibration logic including:
a set of delay logic modules coupled to the first, second and third LCoS assemblies, and
control logic to receive data from the plurality of detectors and to control the delay logic modules responsive to the data from the plurality of detectors.

12. The system of claim 11, wherein:
The detectors are positioned on a screen, the screen positioned at a distance from the output optics element to receive an image from the output optics element for viewing by a group of people.

13. The system of claim 11, wherein:
The detectors are coupled to the housing physically in a calibration subsystem proximate to the housing and apart from a screen distant from the housing for receiving images from the housing.

14. The system of claim 11, further comprising:
An optical component positioned at an outlet of the housing to receive calibration light from the second beam recombiner, the calibration light corresponding to light provided by the output optics, the optical component further positioned to provide the calibration light to the plurality of detectors.

15. The system of claim 14, wherein
The optical component includes a lens coupled to a mirror.

16. The system of claim 11, wherein:
The detectors of the plurality of detectors are CCD row elements.

17. The system of claim 11, wherein:
The detectors of the plurality of detectors are each split silicon light detectors.

18. A method, comprising:
Detecting alignment of a first image;
Providing data indicating alignment of the first image; And
Adjusting the first image responsive to the data.

19. The method of claim 18, further comprising:
Detecting alignment of a second image;
Providing data indicating alignment of the first image with the second image; And
Adjusting the second image responsive to the data.

20. The method of claim 18, wherein:
Detecting alignment includes detecting registration errors, magnification and rotation.
